(19) United States
(12) Patent Application Publication
(10) Pub. No.: US 2008/0249980 A1
(43) Pub. Date: Oct. 9, 2008

(54) METHOD FOR CLASSIFYING TERMS OF LEGAL DOCUMENTS

(75) Inventors: Piao YU, Tu-Cheng (TW); Cheng-Yi HUANG, Tu-Cheng (TW); Yi-Hua TANG, Shenzhen (CN); Xiao GU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/966,998

(22) Filed: Dec. 29, 2007

(30) Foreign Application Priority Data
Apr. 6, 2007 (CN) 200710200406.4

(51) Int. Cl. G06F 7/08; G06F 17/30

(52) U.S. Cl. 707/2; 707/E17.002

(57) ABSTRACT

A method for classifying terms and conditions of legal documents is provided. The method includes the steps of: standardizing terms and conditions of all of the legal documents stored in a database; classifying the all of the legal documents having standardized terms and conditions into different categories according to different areas of practices; extracting universal terms and conditions of each of the categories; extracting universal terms and conditions of all of the legal documents in all categories; and extracting categorical terms and conditions of each of the categories.

### BACKGROUND OF THE INVENTION

1. Field of the Invention

The present invention relates to a method for classifying terms of legal documents.

2. Description of Related Art

Legal entities use a number of tools to complete tasks regarding legal documentation. Modern commercial relationships involve multiple business partners and processes throughout the supply chain. This complexity affects terms and conditions entries corresponding to business liabilities, which relates to costs, shipments, payments, qualities, volume breaks, rebate policies, discounts, and so forth. Managing all of these requires a serious commitment of time and resources. Today, a typical enterprise has to associate with a variety of vendors, suppliers, service providers, and such by using contracts, agreements, or other types of legal documents.

Legal documents are used in almost all areas of commerce. Most conventional legal documents are reviewed, accepted, and signed using an inefficient, manually irritating process. This seriously affects the efficiency of the businesses. In recent years, software programs related to legal document management have been adopted and used by many organizations. However, interfaces provided by the software programs are often text-based and cumbersome to use. Furthermore, the software programs also lack functionalities that allow terms of legal documents to be efficiently updated and shared.

What is needed, therefore, is a method that can provide functions of classifying terms of legal documents throughout the stages of maintenance, and analysis.

### SUMMARY OF THE INVENTION

A method for classifying terms of legal documents is provided. The method includes the steps of: standardizing terms and conditions of all of the legal documents stored in a database; classifying all of the legal documents having standardized terms and conditions into different categories according to different areas of practices; extracting universal terms and conditions of each of the categories; extracting universal terms and conditions of all of the legal documents in all categories; and extracting categorical terms and conditions of each of the categories.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for classifying terms of legal documents in accordance with a preferred embodiment;

FIG. 2 is a schematic diagram of main software function modules of an application server of FIG. 1;

FIG. 3 is a flowchart of a method for classifying terms of legal documents in accordance with a preferred embodiment; and

FIG. 4 is a flowchart of a method for a user to apply classified terms of FIG. 3 to generate an acceptable legal document.

### DETAILED DESCRIPTION OF THE INVENTION

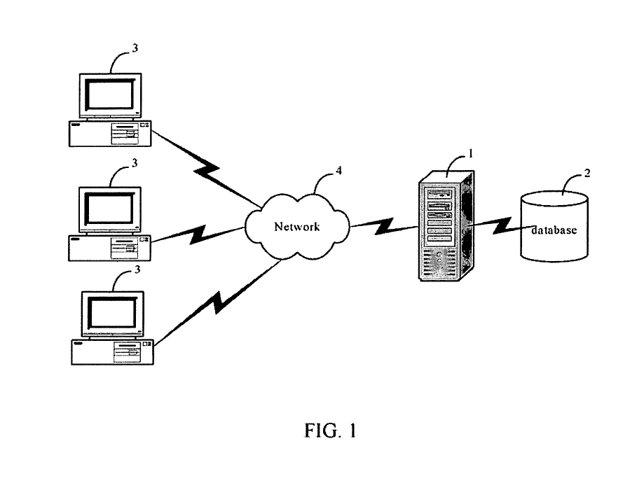

FIG. 1 is a schematic diagram of a hardware configuration of a system for classifying terms of legal documents (hereinafter, “the system”) in accordance with a preferred embodiment. The system includes an application server 1, a database 2, and a plurality of clients 3 (only three shown). The application server 1 communicates with the clients 3 via a network 4. The network 4 may be an intranet, the Internet, or any other types of communications links. Each of the plurality of clients 3 is configured (i.e., structured and arranged) for providing an interactive interface that enables users to perform relevant operations so as to classify terms of the legal documents. The users may belong to different departments, such as a sales department, a purchasing department, a financial department, a legal department, or any other affiliates of an enterprise and/or a contracting party of the enterprise.

The application server 1 further connects to the database 2. The database 2 is configured for storing related data, such as legal documents and different terms of the legal documents. In the preferred embodiment, the legal documents are contracts. In other embodiments, the legal documents may be agreements, and indictments, etc.

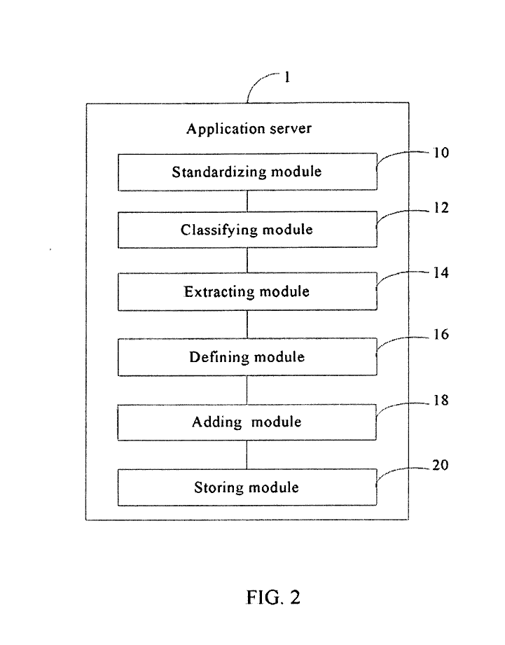

FIG. 2 is a schematic diagram of main software function modules of the application server 1. The application server 1 may include a standardizing module 10, a classifying module 12, an extracting module 14, a defining module 16, an adding module 18, and a storing module 20.

The standardizing module 10 is configured for standardizing terms and conditions of all of legal documents stored in the database 2. The standardized terms and conditions in a particular category of legal documents may have the same expressions.

The classifying module 12 is configured for classifying all of the legal documents having standardized terms and conditions into different categories according to different areas of practices. For example, the legal documents (i.e., contracts) may be classified into the following categories: lease agreements, project contracts, service contracts, employment contracts, and business contracts, etc.

The extracting module 14 is configured for extracting universal terms and conditions of each of the categories. The universal terms and conditions of the category are applicable to all of the legal documents in the same category.

The extracting module 14 is also configured for extracting universal terms and conditions of all the categories according to the universal terms of each category. The universal terms and conditions of all the categories are selected from the universal terms and conditions of each of the categories and are applicable to each of the legal documents regardless of the category of the legal document.

The extracting module 14 is further configured for extracting categorical terms and conditions of each of the categories. The categorical terms and conditions are applicable to a particular legal document in a category.

The defining module 16 is configured for defining attributes of each of the universal terms, and conditions and the categorical terms and conditions. The attributes of each of the universal terms and conditions, and the categorical terms and conditions may be defined as a fixed term and condition or a modifiable term and condition.

The adding module 18 is configured for adding extra terms and conditions in the database 2. The extra terms and conditions can be inserted into the universal terms and conditions, and the categorical terms and conditions so as to expand the terms and conditions.

The storing module 20 is configured for storing the universal terms and conditions, the categorical terms and conditions, extra terms and conditions, and the attributes of each of terms and conditions in the database 2.

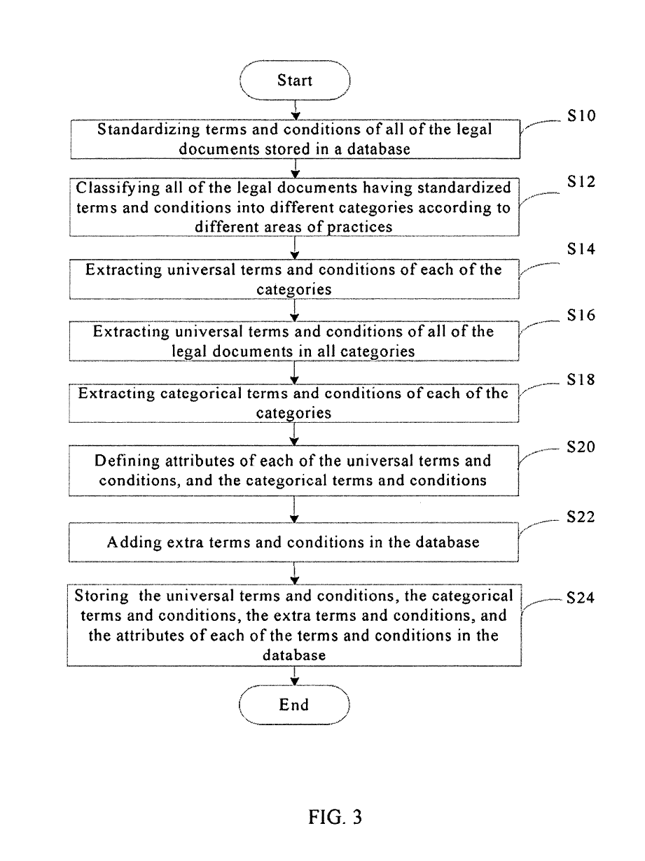

FIG. 3 is a flowchart of a method for classifying terms of legal documents in accordance with a preferred embodiment. In step S10, the standardizing module 10 standardizes terms and conditions of all of the legal documents stored in the database 2.

In step S12, the classifying module 12 classifies all of the legal documents having standardized terms and conditions into different categories according to different areas of practices.

In step S14, the extracting module 14 extracts universal terms and conditions of each of the categories. The universal terms and conditions of a category are applicable to all of the legal documents in the same category.

In step S16, the extracting module 14 extracts universal terms and conditions of all categories according to the universal terms and conditions of each of the categories. The universal terms and conditions of all of the legal documents are selected from the universal terms and conditions of each of the categories and are applicable to each legal document regardless of the category of the legal document.

In step S18, the extracting module 14 extracts categorical terms and conditions of each of the categories. The categorical terms and conditions are applicable to a particular legal document in a category.

In step S20, the defining module 16 defines attributes of each of the universal terms and conditions, and the categorical terms and conditions.

In step S22, the adding module 18 adds extra terms and conditions in the database 2.

In step S24, the storing module 20 stores the universal terms and conditions, the categorical terms and conditions, the extra terms and conditions, and the attributes of each of the terms and conditions in the database 2.

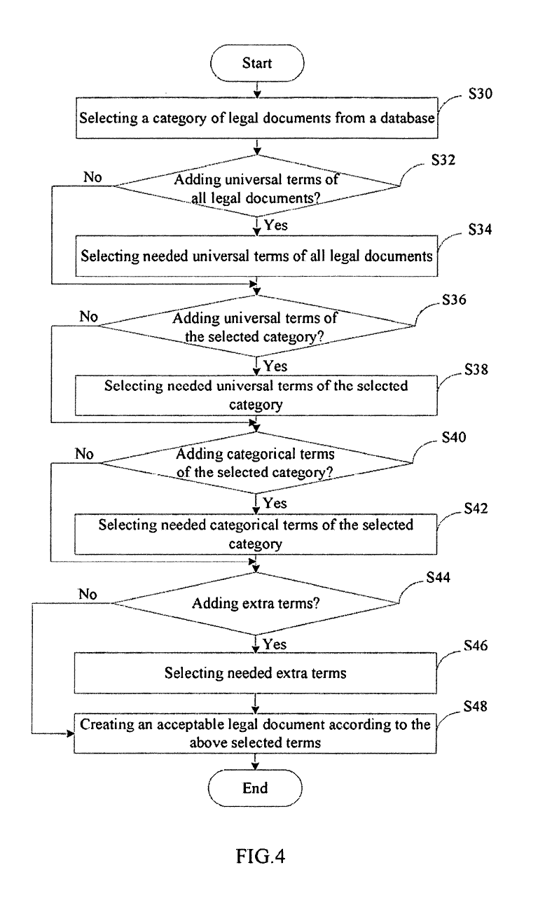

FIG. 4 is a flowchart of a method for a user to apply the classified terms of FIG. 3 to generate an acceptable legal document. In step S30, the user selects a category of legal documents to which the legal document to be generated belongs from the database 2.

In step S32, the user determines whether there is need to add universal terms and conditions of all of the legal documents to the legal document.

In step S34, the user selects needed universal terms and conditions of all of the legal documents if there is need to add universal terms and conditions of all of the legal documents.

In step S36, the user determines whether there is need to add universal terms and conditions of the selected category to the legal document.

In step S38, the user selects needed universal terms and conditions of the selected category if there is need to add universal terms and conditions of the selected category.

In step S40, the user determines whether there is need to add categorical terms and conditions of the selected category to the legal document.

In step S42, the user selects needed categorical terms and conditions of the selected category if there is need to add categorical terms and conditions of the selected category.

In step S44, the user determines whether there is need to add extra terms and conditions to the legal document.

In step S46, the user selects needed extra terms and conditions if there is need to add extra terms and conditions.

In step S48, the system creates an acceptable legal document according to the above selected terms.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A method for classifying terms of legal documents, the method comprising:
standardizing terms and conditions of all of the legal documents stored in a database;
classifying all of the legal documents having standardized terms and conditions into different categories according to different areas of practices;
extracting universal terms and conditions of each of the categories;
extracting universal terms and conditions of all of the legal documents in all categories; and
extracting categorical terms and conditions of each of the categories.

2. The method according to claim 1, further comprising:
defining attributes of each of the universal terms and conditions, and the categorical terms and conditions;
adding extra terms and conditions in the database; and
storing the universal terms and conditions, the categorical terms and conditions, the extra terms and conditions, and the attributes of each of the terms and conditions in the database.

3. The method according to claim 1, wherein the universal terms and conditions of a category are applicable to all of the legal documents in the same category.

4. The method according to claim 1, wherein the universal terms and conditions of all legal documents are selected from the universal terms and conditions of each category and are applicable to each legal document regardless of the category of the legal document.

5. The method according to claim 1, wherein the categorical terms and conditions of each category are applicable to a particular legal document in a category.

6. The method according to claim 1, further comprising a step of applying the classified terms and conditions to generate an acceptable legal document.
